(19) United States
(12) Patent Application Publication
(10) Pub. No.: US 2008/0222139 A1
(43) Pub. Date: Sep. 11, 2008

(54) Method and Apparatus for Providing Instant-Review of Multimedia Material

(75) Inventor: Willem Peter Van Der Brug, Best (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/996,613

(22) PCT Filed: Jul. 24, 2006
(86) PCT No.: PCT/IB06/52534

§ 371 Date: Jan. 24, 2008

Related U.S. Application Data
(60) Provisional application No. 60/702,819, filed on Jul. 27, 2005.

(51) Int. Cl. G06F 17/30

(52) U.S. Cl. 707/5; 707/103 R; 707/E17.014

(57) ABSTRACT

A method for organizing data in a multimedia presentation (100) providing for an instant summary review is disclosed. Further disclosed is a method and apparatus for presenting summary information (102, 104) up to a current scene in a multimedia presentation (100). The method of presenting summary information comprises the steps of determining the current scene (420) in a received multimedia presentation (100), determining a summary data block corresponding to the determined current scene (430), and providing information in the corresponding summary data block to a user in response to a received request (450). In one aspect of the invention, each summary data block associated with prior scenes is obtained and filtered based on the current scene to provide a summary length that is substantially constant independent of the current scene.

The invention is related to the field of multimedia presentation and, more specifically, to a method and apparatus for providing an instant review feature of multimedia material.

When users or groups of users are watching a DVD or other multimedia material, it often occurs that another user may want to join the users or user groups. The users or user group already watching the media, e.g., a movie, have the option to restart the movie from the beginning, or to quickly explain the story or movie lineup to the point where the new user has joined the group, or do nothing. In the latter case, the new user may elect to ascertain the story or movie line, join the group without knowledge of the story line, or not join the group at all.

Current DVD technology, for example, provides for starting the presentation of multimedia data, e.g., a movie, at sections other than the presentation's beginning. However, jumping over sections of a presentation is useful when a user fails to completely view a movie in one sitting and decides to pick up the presentation at a latter time. However, this feature fails to provide any information regarding the storyline up to the point the movie was paused. In this case, while the user may restart the presentation at a point other than the beginning, the user may have forgotten the storyline up to this restarting point. Thus, the user is forced to restart the presentation from the beginning to review the storyline.

Hence, there is a need in the industry for providing a summary of information up to a current viewing point in the multimedia presentation and for processes suitable for decoding and presenting the summary information on demand.

A method for organizing data in a multimedia presentation providing for an instant summary review is disclosed. Further disclosed is a method and apparatus for presenting summary information up to a current scene in a multimedia presentation. The method of presenting summary information comprises the steps of determining the current scene in a received multimedia presentation, determining a summary data block corresponding to the determined current scene, and providing information in the corresponding summary data block to a user in response to a received request. In one aspect of the invention, each summary data block associated with a prior scene is obtained and filtered based on the current scene to provide a summary length that is substantially constant, independent of the current scene.

The invention may take form in various components and arrangements of components, and in various process operations and arrangements of process operations. The drawings are only for the purpose of illustrating preferred embodiments and are not to be construed as limiting the invention.

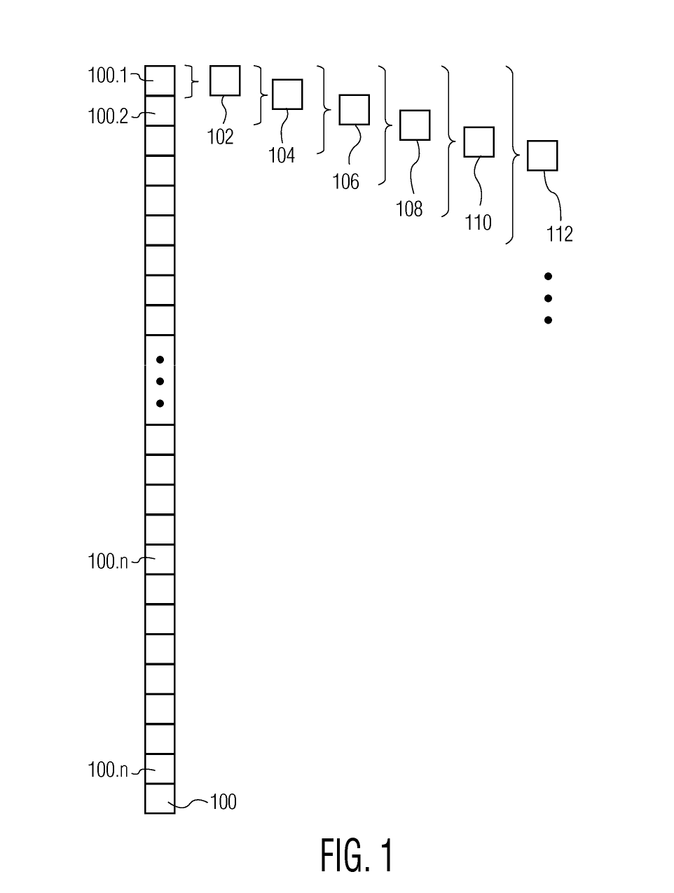

FIG. 1 illustrates a block diagram of a first exemplary organization of information in accordance with the principles of the invention;

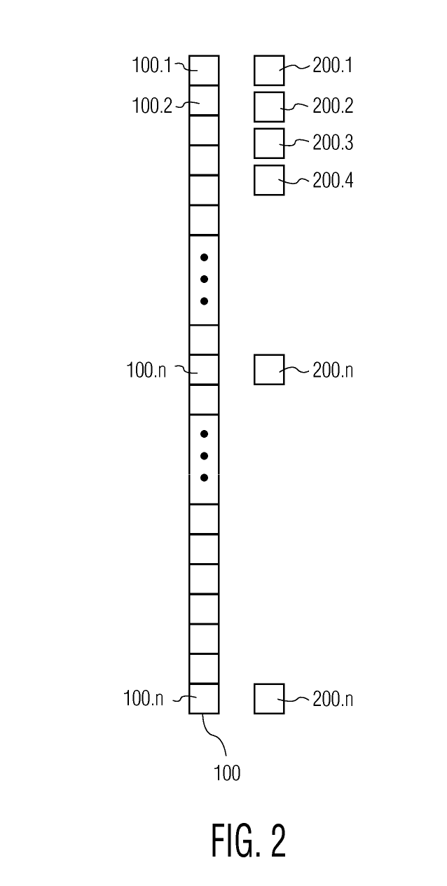

FIG. 2 illustrates a block diagram of a second exemplary organization of information in accordance with the principles of the invention;

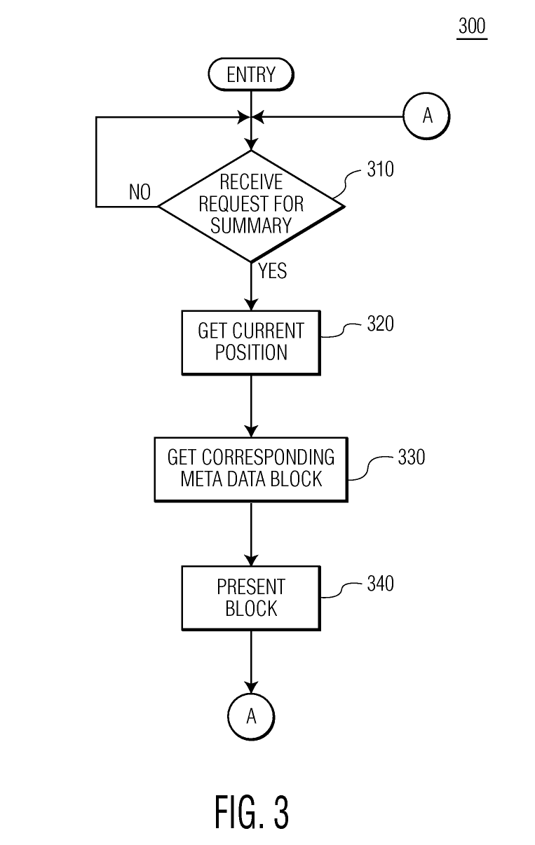

FIG. 3 illustrates a flowchart of a first exemplary process for processing the summary information in accordance with the principles of the invention;

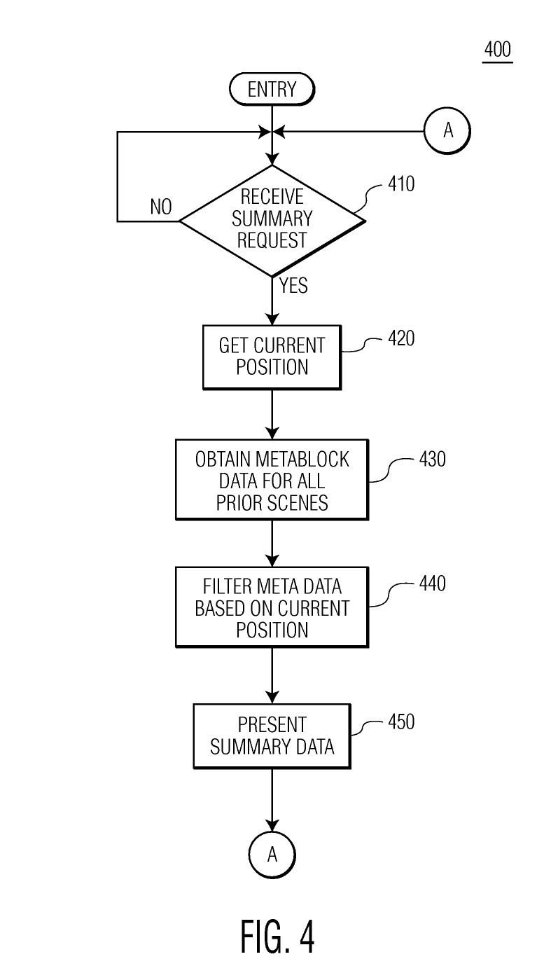

FIG. 4 illustrates a flowchart of a second exemplary process for processing the summary information in accordance with the principles of the invention; and

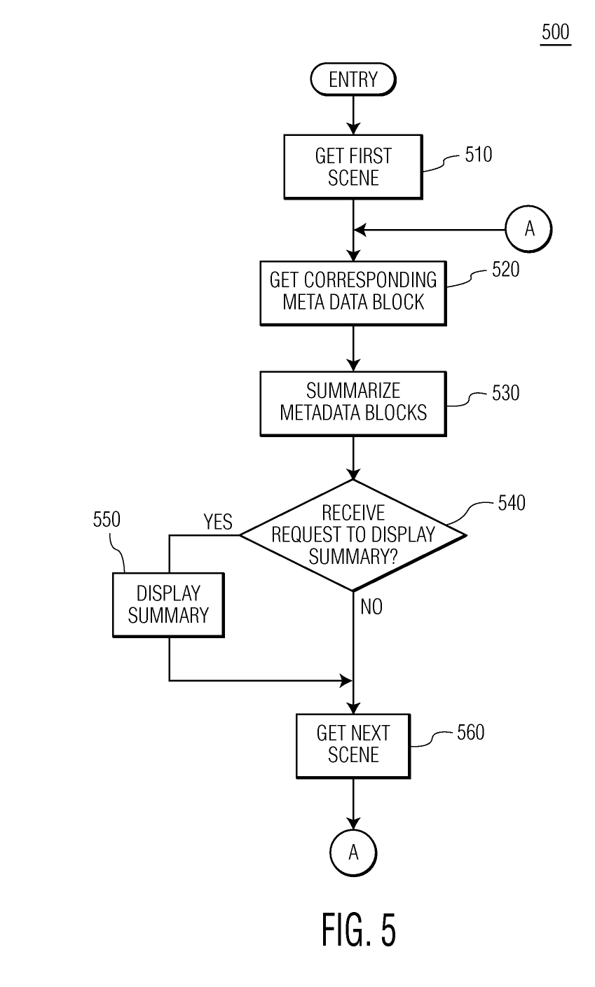

FIG. 5 illustrates a flowchart of a third exemplary process for processing the summary information in accordance with the principles of the invention.

It is to be understood that these drawings are for purposes of illustrating the concepts of the invention and are not drawn to scale. It will be appreciated that the same reference numerals, possibly supplemented with reference characters where appropriate, have been used throughout to identify corresponding parts.

In accordance with the principles of the invention, summary metadata and specific summary audio/visual (A/V) content can be added to new disc standards, such as Blu-ray Disc or HD-DVD. In this case, a playback device may implement a standardized summary functionality.

The metadata, i.e., information, added to the disc standard may be a specific set of in-out pointers in the multimedia timeline presentation. Several sets of in-out points may be defined with different detailed? levels to satisfy the requirement of non-proportional summary length. In another aspect of the invention, each in-out pointer set could include a priority classification such that a short summary of almost the entire movie would only use the highest priority in-out pointers.

In another aspect, the summary A/V content may be defined such that the in-out pointers and priority indicators are able to generate summaries of specific lengths for subsequent presentation. In this case, the playback device will generate specific summary data by generating the data based on the current position of the playback function.

FIG. 1 illustrates a first embodiment of an exemplary organization of multimedia summary metadata in accordance with the principles of the invention. In this exemplary embodiment of the invention, multimedia 100 is divided into a plurality of section, i.e., scenes, 100.1-100.m. For each scene, a corresponding metadata block 102, 104, 105, 108, etc. is defined. Each metadata block provides a summary of the information (or in-out points) in corresponding scenes. For example, metadata 102 contains summary data for scene 100.1, metadata 104 contains summary data for scenes 100.1 and 100.2, metadata 106 contains summary data (or a set of in-out points) for scenes 100.1-100.3, etc. In this manner, the summary information that is presented to the user may be of a fixed length, and in one aspect it may be substantially the same length. As it would be appreciated, the summary data further includes a reference to the corresponding scene.

In this exemplary embodiment, a playback device, having knowledge of the current position along the multimedia presentation 100 may provide a summary of the prior scenes by accessing the metadata block corresponding to the current position of multimedia presentation 100.

In a variation of an embodiment of the invention, the in-out points in the scenes 100.1-100.m are only defined for the video. For audio, a separate audio track is available that specifically explains the story lineup to the current scene.

FIG. 2 illustrates a second embodiment of an exemplary organization of multimedia data in accordance with the principles of the invention. In this exemplary organization, for each multimedia scene, 100.1, 100.2, etc., a metadata block 200.1, 200.2, etc., is associated with the scene and includes information that summarizes the corresponding scene. In another aspect of the invention, a metadata block corresponding to a scene may contain summary information of the previous scene. In this case, when the current position in the multimedia presentation is determined, the corresponding metadata block contains the summary of the previous scene(s), and, hence, a summary of the scene at the current position is not presented before the scene at the current position is viewed.

FIG. 3 illustrates a flow chart 300 of an embodiment of a first exemplary process for processing the summary data (metadata block) contained on a multimedia medium in accordance with the principles of the invention. In this exemplary embodiment a determination is made at block 310 whether a request for summary information has been received. If the answer is in the affirmative, then the current position within the multimedia medium is obtained at block 320. At block 330, the metadata block associated with the current position is obtained and then displayed or presented at block 340.

As it would be recognized, for the metadata block organization shown in FIG. 1, the processing shown in FIG. 3 provides a summary of the multimedia presentation from the beginning of the presentation to the current position. However, for the metadata block organization shown in FIG. 2, the processing shown in FIG. 3 may provide a summary of the scene at the current position or at the previous position, depending upon the relationship between metadata blocks and scenes, as described previously.

FIG. 4 illustrates a flow chart 400 of an embodiment of a second exemplary process for processing the summary data contained on a multimedia medium in accordance with the principles of the invention. In this exemplary embodiment, a determination is made at block 410, whether a request for summary information is received. If the answer is in the affirmative, then the current position in the multimedia presentation is obtained at block 420. At block 430, each metadata block prior, and, alternatively, corresponding, to the current position are obtained at block 440. At block 440 the information in the metadata blocks are filtered to reduce the amount of information to be presented. In one aspect, the information is filtered to limit the length of the summary information. In another aspect, the metadata block may provide indications as to how or which information is to be selected for filtering. This filtering may further be based on the current position or scene. At block 450, the summary data is presented. In an alternate embodiment, all the metadata information may be presented to the viewer. In this case, the length of the summary is variable and depends upon the current position within the multimedia presentation.

FIG. 5 illustrates a flow chart 500 of an embodiment of a third exemplary process for processing the summary data contained on a multimedia medium in accordance with the principles of the invention. In this exemplary embodiment, a first scene is selected at block 510. At block 520 a metadata block corresponding to the selected is obtained. At block 530, a summary of the metadata blocks obtained so far is determined. This summary may be obtained in a manner similar to the filtering described with regard to FIG. 4.

At block 540, a determination is made whether a request for summary information has been received. If the answer is in the affirmative, then the summary information is provided or displayed at block 530.

Otherwise, the next scene is obtained at block 560 and processing continues at block 520.

As it would be recognized, the processing shown in FIG. 5 provides for dynamic determination of the summary information to the current position of the multimedia presentation. Thus, in one aspect, when the metadata is organized as shown in FIG. 1, the determination of the summary may be simply obtaining the corresponding metadata block. On the other hand, when the metadata is organized as shown in FIG. 2, the summary may be determined, in real-time, by processing each of the metadata blocks up to the current position.

In another aspect of the invention, when the instant review function is activated by the user, the system may respond with a question “How brief do you want the summary to be?,” with the user being able to answer “very short,” “normal,” or “comprehensive.” Depending on the selection, fewer or more summary scenes or in-out points into the audio/video material may be presented. Hence, an indicator may be included in each metadata block corresponding to the exemplary “very short,” “normal,” and “comprehensive” modes. In this case, the indicator may be used to filter the information to display a desired level of information.

In yet another aspect of the invention, the receiving device as it receives the multimedia presentation may analyze the information or content of each scene and prepare a summary of the multimedia presentation. In this aspect of the invention, the receiving device may dynamically prepare the summary and provide or present the summary either in real-time or in response to a request by the user.

A system according to the invention to execute the processing shown herein may be embodied in a receiving system containing hardware, a programmable processing or computer system that may be embedded in one or more hardware/software devices, loaded with appropriate software or executable code. The system can be realized by means of a computer program. The computer program will, when loaded into a programmable device, cause a processor in the device to execute the method according to the invention. Thus, the computer program enables a programmable device to function as the system according to the invention.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, although the invention has been discussed with regard to positions or scenes within a multimedia presentation, it would be recognized that the terms, positions, and scenes are used interchangeably and refer to a timeline, measured from the beginning of the multimedia presentation.

It is expressly intended that all combinations of those elements that perform substantially the same function in substantially the same way to achieve the same results are within the scope of the invention. Substitutions of elements from one described embodiment to another are also fully intended and contemplated.

1. A method for organizing a summary of multimedia presentation (100) containing a plurality of scenes (100.1, 100.2), the method comprising the steps of:
providing, for each scene (100.1, 100.2) in the multimedia presentation, a data block containing a summary corresponding to the scene (102, 104); and
providing an indicator referencing each of the scenes associated with the summary data.

2. The method as recited in claim 1, wherein the summary is associated with information in a corresponding scene.

3. The method as recited in claim 1, wherein the summary is associated with information in a previous scene.

4. The method as recited in claim 1, wherein the summary is associated with each of the scenes prior to a corresponding scene.

5. The method as recited in claim 5, wherein the summary includes the corresponding scene.

6. The method as recited in claim 1, wherein the summary corresponds to a visual portion of each of the scenes of the multimedia presentation.

7. The method as recited in claim 1, wherein the summary corresponds to an audio portion of each of the scenes of the multimedia presentation.

8. The method as recited in claim 1, wherein the summary further comprises an indicator for filtering the summary based on the current scene in the multimedia presentation.

9. A method for providing a summary of multimedia presentation (100), containing a plurality of scenes (100.1, 100.2) and corresponding summary data blocks (200.1, 200.2), up to a current scene in the presentation, the method comprising the steps of:
determining the current scene (320) in a received multimedia presentation;
determining a summary data block (330) corresponding to the determined current scene; and
providing information in the corresponding summary data block (340) to a user in response to a received request.

10. The method as recited in claim 9, wherein the step of determining a corresponding summary data block further comprises the step of:
obtaining each summary data block prior to the determined current scene (430).

11. The method as recited in claim 10, further comprising the step of:
filtering the information in each of the summary data blocks (440).

12. The method as recited in claim 11, wherein the filtering step comprises the steps of:
obtaining an indicator in each of the summary data blocks; and
limiting the information from each of the summary data blocks based on the obtained indicator and the determined current scene.

13. The method as recited in claim 9, wherein the information in the summary data blocks is associated with the visual portion of the multimedia presentation.

14. The method as recited in claim 9, wherein the information in the summary data blocks is associated with the audio portion of the multimedia presentation.

15. An apparatus for providing a summary of a multimedia presentation, containing a plurality of scenes and corresponding summary data blocks, up to a current scene in the presentation, the apparatus comprising:
a processor and a memory, the processor executing a code for:
determining the current scene (420) in a received multimedia presentation;
determining a summary data block corresponding to the determined current scene (430); and
providing information in the corresponding summary data block to a user in response to a received request (450).

16. The apparatus as recited in claim 15, wherein the processor determines a corresponding summary data block by executing a code for:
obtaining each summary data block prior (430) to the determined current scene.

17. The apparatus as recited in claim 16, the processor further executing a code for:
filtering the information in each of the summary data blocks (440).

18. The apparatus as recited in claim 17, wherein the processor filters the information by executing a code for:
obtaining an indicator in each of the summary data blocks; and
limiting the information from each of the summary data blocks based on the indicator and the determined current scene.

19. The apparatus as recited in claim 15, wherein the information in the summary data blocks is associated with the visual portion of the multimedia presentation.

20. The apparatus as recited in claim 15, wherein the information in the summary data blocks is associated with the audio portion of the multimedia presentation.

21. The apparatus as recited in claim 15, further comprising:
a receiving unit for receiving the multimedia presentation.

22. The apparatus as recited in claim 15, wherein the code is stored in the memory.

23. The apparatus as recited in claim 15, wherein the summary is associated with information in a corresponding scene.

24. The apparatus as recited in claim 15, wherein the summary is associated with information in a previous scene.

25. The apparatus as recited in claim 15, wherein the summary is associated with each of the scenes prior to a corresponding scene.

26. The apparatus as recited in claim 25, wherein the summary includes the corresponding scene.

27. An apparatus for providing a summary of a multimedia presentation, containing a plurality of scenes, the apparatus comprising:
a processor and a memory, the processor executing a code for:
reviewing the content of the multimedia presentation up to a current scene;
preparing a summary of the content of the multimedia presentation up the current scene; and
providing the summary of the content to a user.

28. The apparatus as recited in claim 27, wherein the processor determines the summary of the content by executing a code for:
reviewing the content of each scene prior to the current scene.

29. The apparatus as recited in claim 28, the processor further executing a code for:
filtering the summary of the content of each of the scenes prior to the current scene.
